(19) United States
(12) Patent Application Publication
(10) Pub. No.: US 2010/0226476 A1
(43) Pub. Date: Sep. 9, 2010

(54) Low-Profile X-Ray Fluorescence (XRF) Analyzer

(76) Inventors: John PESCE, Melrose, MA (US); Kenneth P. Martin, Somerville, MA (US); Paul G. Martin, Copacabana (AU)

Correspondence Address: THERMO FINNIGAN LLC, 355 RIVER OAKS PARKWAY, SAN JOSE, CA, 95134, US

(21) Appl. No.: 12/718,789

(22) Filed: Mar. 5, 2010

Related U.S. Application Data
(60) Provisional application No. 61/157,844, filed on Mar. 5, 2009.

(51) Int. Cl. G01N 23/223

(52) U.S. Cl. 378/44

(57) ABSTRACT

A low-profile, hand-holdable, self-contained x-ray fluorescence (XRF) analyzer includes an articulated head. Orientation of the head, relative to a body of the analyzer, may be user adjusted, manually and/or via remote control. A primary x-ray source and an x-ray detector are disposed within the head for articulation therewith. The analyzer may be inserted into a small diameter pipe or other hollow structure, and then the orientation of the head may be adjusted, so a business end of the head is oriented toward a portion of the interior of the pipe or other structure that is to be analyzed. Alternatively, a primary x-ray source and an x-ray detector are disposed within a fixed-orientation head, such that the business end axis of the analyzer is oriented approximately perpendicular to the main axis of the body. Optionally, one or more light sources and cameras may be used to generate images of regions near either of the analyzers to facilitate positioning the analyzer adjacent the sample and, in the case of the articulated head analyzer, orienting the head toward the sample.

### CROSS-REFERENCE TO RELATED APPLICATION

This application claims the priority benefit under 35 U.S.C. §119(e)(1) of U.S. Provisional Patent Application No. 61/157,844 by John Pesce et al. entitled “Low-Profile X-Ray Fluorescence (XRF) Analyzer”, filed Mar. 5, 2009, the disclosure of which is herein incorporated by reference.

### TECHNICAL FIELD

The present invention relates to hand-holdable x-ray fluorescence (XRF) analyzers and, more particularly, to low-profile XRF analyzers.

### BACKGROUND ART

Analyzing elemental composition of samples is important in many contexts, including identifying and segregating metal types in metal recycling facilities, quality control testing in factories and forensic work. Several analytical methods are available. One common analysis method employs x-ray fluorescence (XRF). When exposed to high energy primary x-rays from a source, each atomic element present in a sample produces a unique set of characteristic fluorescence x-rays that are essentially a fingerprint for the specific element. An x-ray fluorescence analyzer determines the chemistry of a sample by illuminating a spot on the sample with x-rays and measuring the spectrum of characteristic x-rays emitted by the different elements in the sample. The primary source of x-rays may be an x-ray tube or a radioactive material, such as a radioisotope.

The term x-rays, as used herein, includes photons of energy between about 1 keV and about 150 keV and will, therefore, include: the characteristic x-rays emitted by an excited atom when it deexcites; bremsstrahlung x-rays emitted when an electron is scattered by an atom; elastic and inelastically scattered photons generally referred to as Rayleigh and Compton scattered radiation, respectively; and gamma rays in this energy range emitted when an excited nucleus deexcites.

At the atomic level, a characteristic fluorescent x-ray is created when a photon of sufficient energy strikes an atom in the sample, dislodging an electron from one of the atom's inner orbital shells. The atom then nearly instantaneously regains stability, filling the vacancy left in the inner orbital shell with an electron from one of the atom's higher energy (outer) orbital shells. Excess energy may be released in the form of a fluorescent x-ray, of an energy characterizing the difference between two quantum states of the atom.

By inducing and measuring a wide range of different characteristic fluorescent x-rays emitted by the different elements in the sample, XRF analyzers are able to determine the elements present in the sample, as well as to calculate their relative concentrations based on the number of fluorescent x-rays occurring at specific energies. When samples with known ranges of chemical composition, such as common grades of metal alloys, are tested, an XRF analyzer can also identify the sample by name, by referencing a programmed table or library of known materials. XRF analyzers may be used to analyze metals, plastics and other materials.

Portable, battery-powered, hand-holdable XRF analyzers are available from the Thermo Niton Analyzers business of Thermo Fisher (Billerica, Mass.), under the tradenames NITON XLi analyzer and NITON XLt analyzer. Known portable XRF analyzers are not, however, suitable for analyzing difficult to reach inside surfaces of small-diameter pipes and other small cavities, in corners and cramped quarter, and the like.

### SUMMARY OF THE INVENTION

An embodiment of the present invention provides an apparatus for analyzing composition of a sample. The apparatus includes a hand-holdable, self-contained, test instrument, such as an XRF analyzer, that includes a body and a head adjustably attached to the body. The orientation of the head, relative to the body, may be user adjustable over a range of at least about 45°. The head houses a source, such as a radioisotope or an x-ray tube, for producing a beam of penetrating radiation. The source may be used to illuminate a spot on the sample. As a result of being illuminated, the sample produces a response signal. The head also houses a detector for receiving the response signal and for producing an output signal. The head may also house other components, such as a preamplifier, x-ray filter and shutter.

The test instrument further includes a processor coupled to the detector. The processor is programmed to process the output signal. The test instrument also includes a battery powering the processor.

The head may be oriented to be in-line with the body, or otherwise, to facilitate inserting the instrument into a pipe or other hollow object, in a corner or cramped quarters, etc. The head may then be reoriented to aim the source and detector toward a sample, such as toward a portion of an inside wall of the pipe or other object. The head swivels, relative to the body, so tests can be made at various angles, relative to the axis of the instrument body. A user-operable latch may releasably secure the head orientation, relative to the body.

In some embodiments, the test instrument includes a high-voltage power supply powered by the battery. The processor, the battery and/or the high-voltage power supply may be housed in the body or in the head. The high-voltage power supply may be coupled to the source, such as an x-ray tube, via separate positive and negative high voltage leads, relative to a common ground within the test instrument.

The test instrument may further include an articulator, which may include a motor and worm wheel, coupled to the body and to the head. The articulator may be configured to adjust the head orientation, relative to the body. A port in the test instrument may be configured to receive signals to remotely control the articulator.

One or more images may be generated, so as to assist a user in positioning the analyzer, such as within a hollow structure, or so as to assist the user in orienting the source of penetrating radiation. The head may house a first digital camera powered by the battery and oriented so as to generate an image of a region within the beam of penetrating radiation. The test instrument may further include a port configured to send a signal conveying a representation of an image from the first digital camera for remote viewing.

Optionally or in addition, the body may house a second digital camera powered by the battery. The test instrument may further include a port configured to send a signal representing an image from the second digital camera for remote viewing.

Another embodiment of the present invention provides a method for analyzing composition of a sample from within a hollow structure. An XRF analyzer is inserted into a void defined by the structure. An orientation of a source of penetrating radiation within the XRF analyzer is changed, relative to a processor of the XRF analyzer, such that an output of the source is oriented toward the sample. A beam of penetrating radiation is generated, thereby illuminating a spot on the sample. A response signal is received from the sample, and an output signal is produced as a result of receiving the response signal. The output signal is processed, such as to produce an analysis of the composition of the sample.

The orientation of the source of penetrating radiation may be remotely controlled. Changing the orientation of the source of penetrating radiation may include: transmitting a remote control signal from outside the hollow structure, receiving the remote control signal and changing the orientation of the source of penetrating radiation in response to the received remote control signal.

One or more images may be generated, so as to assist a user in positioning the analyzer within the hollow structure, or so as to assist the user in orienting the source of penetrating radiation. A digital image of a region within the hollow structure may be generated. A signal conveying a representation of the digital image may be transmitted. The transmitted signal may be received, and the representation of the digital image may be displayed outside the hollow structure.

Optionally or alternatively, the method includes generating a digital image of a region that is within the beam of penetrating radiation, or that would be within the beam of penetrating radiation if the orientation of the source of penetrating radiation were changed. A signal conveying a representation of the digital image may be transmitted. The transmitted signal may be received, and the representation of the digital image may be displayed outside the hollow structure.

Optionally, the XRF analyzer may be inserted by carrying the XRF analyzer on a robot. The robot may be remotely controlled. The robot may be automatically controlled, such as by sensing its location and comparing its location to one or more predetermined locations of interest. Optionally, the robot or the XRF analyzer may automatically determine locations of interest by analyzing images captured by a digital camera in the XRF analyzer or on the robot.

Yet another embodiment of the present invention provides an apparatus for analyzing composition of a sample. The apparatus includes a hand-holdable, self-contained, low profile test instrument that includes a body. A business end of the test instrument is configured such that a business end axis is orientated approximately perpendicular to a major axis of the body. The business end includes a source for producing a beam of penetrating radiation. The source may be used to illuminate a spot on the sample, thereby producing a response signal from the sample. The business end also includes a detector for receiving the response signal and for producing an output signal. The test instrument further includes a processor coupled to the detector. The processor is programmed to process the output signal. A battery powers the processor.

The source for producing the beam of penetrating radiation may be a radioisotope or an x-ray tube. If the source is an x-ray tube, the body may house a high-voltage power supply powered by the battery and coupled to the x-ray tube. The processor and the battery may be housed within the body.

The business end may further include a digital camera powered by the battery. The camera may be oriented so as to generate an image of a region within the beam of penetrating radiation. The test instrument may further include a port configured to send a signal conveying a representation of an image from the digital camera for remote viewing.

The body may include a digital camera powered by the battery. The test instrument may further include a port configured to send a signal representing an image from the digital camera for remote viewing.

### BRIEF DESCRIPTION OF THE DRAWINGS

The invention will be more fully understood by referring to the following Detailed Description of Specific Embodiments in conjunction with the Drawings, of which:

FIG. 1 is a schematic diagram of a self-contained, hand-holdable XRF analyzer according to the prior art;

FIG. 2 is a perspective view of a typical in-line analyzer, according to the prior art;

FIG. 3 is a perspective view of the analyzer of FIG. 2 attached to an extension arm, according to the prior art;

FIG. 4 is a perspective view of a typical pistol grip analyzer attached to an extension arm, according to the prior art;

FIG. 5 is a perspective view of a self-contained, hand-holdable XRF analyzer having an articulated head, according to one embodiment of the present invention;

FIG. 6 is a perspective view of the analyzer of FIG. 5, with the articulated head oriented at an angle, relative to the body, according to one embodiment of the present invention;

FIG. 7 is a more detailed perspective schematic diagram of the head of the analyzer of FIGS. 5 and 6, according to one embodiment of the present invention;

FIG. 8 is a cut-away, perspective view of a motorized hinge mechanism of the analyzer of FIGS. 5-7, according to one embodiment of the present invention;

FIG. 9 is a cut-away view of a pipe, into which the analyzer of FIGS. 5-8 has been inserted;

FIG. 10 is a cut-away view of the pipe of FIG. 9, with the head of the analyzer of FIGS. 5-8 oriented so as to take a measurement of a sample on an inside wall of the pipe, according to one embodiment of the present invention;

FIG. 11 is a schematic block diagram of an XRF analyzer that uses a radioisotope as a source of primary x-rays, according to one embodiment of the present invention;

FIG. 12 is a schematic block diagram of an XRF analyzer that uses an x-ray tube as a source of primary x-rays, according to one embodiment of the present invention;

FIG. 13(A-B) contains a flowchart depicting operations that may be performed to analyze an inner portion of a pipe or other structure, according to one embodiment of the present invention;

FIG. 14 is a is a cut-away view of a pipe, into which an analyzer having a fixed-orientation business end, according to another embodiment of the present invention, has been inserted; and

FIG. 15 is a is a cut-away view of a portion of the pipe of FIG. 14, into which an analyzer having a fixed-orientation business end, according to yet another embodiment of the present invention, has been inserted.

### DETAILED DESCRIPTION OF SPECIFIC EMBODIMENTS

In accordance with embodiments of the present invention, methods and apparatus are disclosed for providing an XRF instrument having a low profile, to facilitate inserting the instrument into a pipe or other hollow object, in a corner or cramped quarters, etc., and then analyzing a sample on a wall of the pipe or other object.

In some embodiments, the instruments have articulated heads. In one such embodiment, an x-ray source, detector with preamplifier, x-ray filtration and shutter are housed in a head that pivots, with respect to a body, so tests can be made at various angles to the axis of the instrument body. Such an instrument may be inserted into a small-diameter pipe, etc. while the head is oriented so as to minimize the profile of the instrument. Then, when a location of interest is reached within the pipe, the head may be reoriented toward the portion of the pipe that is to be analyzed. After the analysis, the head may again be oriented to as to minimize the profile of the instrument to facilitate removing the instrument from the pipe.

In other embodiments, the instruments have low-profile bodies with fixed-orientation heads whose business ends are aimed approximately perpendicular to the instrument bodies. The low-profile bodies facilitate inserting the instruments into pipes, etc.

In yet another embodiment, a remotely controlled or autonomous robot transports an articulated-head or fixed-orientation XRF instrument to one or more points of interest within a pipe or other hollow object. The instrument takes measurements, then the robot withdraws the instrument from the hollow object.

### DEFINITIONS

A “sample,” as the term is used herein, means at least a portion of a material that is to be tested or analyzed.

“Hand holdable,” as the term is used herein, means small enough and light weight enough to be held without additional support and operated by a single hand of an adult.

“Self-contained,” as the term is used herein, means all components necessary for carrying out an analysis within design specifications of an analyzer are contained within, or attached directly to the outside of, the analyzer. For example, a processor and/or display screen of a self-contained analyzer may be provided by a personal digital assistant (PDA) mounted directly on the analyzer.

“Business end axis,” as the term is used herein, means an axis of an analytical instrument. The business end axis is determined by: (a) an axis of a source, within the instrument, for producing a beam of penetrating radiation for illuminating a spot on a sample and, thereby, producing a response signal from the sample, and (b) an axis of a detector, also within the instrument, for receiving the response signal. In use, the source axis forms an angle with the surface of the sample, and the detector axis forms an angle with the surface of the sample. When the instrument is oriented such that the source and detector angles are within design ranges, the business end axis is approximately normal to the surface of the sample.

“Body,” as the term is used herein, means a housing, within which most components of an analyzer are disposed. An analyzer, such as an “in-line” style analyzer, may be held by its body. However, if an analyzer includes a dedicated appendage, such as a handle attached to a body (as in the case of a “pistol grip” analyzer), the handle is not considered part of the body.

### Elemental Analysis Using X-Ray Fluorescence (XRF)

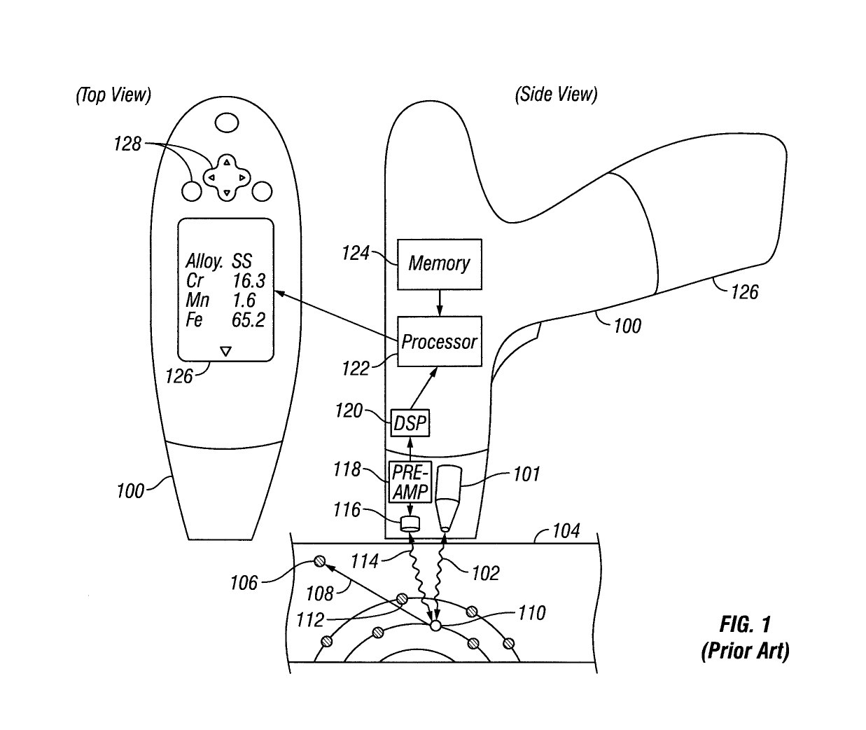

FIG. 1 is a schematic diagram of a prior-art, self-contained, hand-holdable XRF analyzer 100 in use. FIG. 1 shows both a top view and a side view of the analyzer 100. A primary x-ray source 101 produces an x-ray beam 102 directed at the surface of a sample 104. The energy of the primary x-ray beam 102 causes inner-shell electrons (shown enlarged in FIG. 1) to be ejected from their orbits in individual atoms of the sample 104. For example, an electron 106 is ejected from an inner (lower energy) shell, as indicated by an arrow 108. A vacancy 110 left by the ejected electron 106 is filled by an electron 112 from an outer (higher energy) shell. The energy difference between the two energy shells involved in the process is generally emitted in the form of x-ray radiation, i.e., a fluorescent x-ray 114. The energy difference is characteristic of the element from which the electron 106 is emitted. Measuring the energy and intensity of the fluorescent x-ray 114 enables the element to be identified and quantified, respectively.

A detector 116 registers individual x-ray events and sends electrical signals to a preamplifier 118. The preamplifier 118 amplifies the signals from the detector 116 and sends the amplified signals to a digital signal processor (DSP) 120. The DSP 120 collects and digitizes the x-ray events occurring over time and sends resulting spectral data to a main processor 122. The processor 122 mathematically analyzes the spectral data and produces a detailed composition analysis. The resulting composition analysis may be compared against data stored in a memory 124 to determine an alloy grade or other designation for the tested sample 104. Results of the analysis are displayed by the processor 122 on a touchscreen 126 on the top portion of the analyzer 100 and, optionally, are stored in the memory 124. Buttons and other controls, such as those indicated at 128, and the touchscreen 126, enable a user to interact with the processor 122. A detachable rechargeable battery 126 powers the processor 122 and other electrical components within the analyzer 100.

Primary filters (not shown) may be introduced between the x-ray source 700 and the sample to adjust the energy versus intensity spectrum of the primary x-ray beam 515. If the primary x-ray source is an x-ray tube, the voltage supplied to the x-ray tube may be varied to adjust the energy of the primary x-ray beam The analyzer 100 also includes a shutter (not shown) to selectively enable or prohibit the primary x-ray beam 102 from exiting the analyzer and striking the surface of the sample 104. The shutter may include a gear rack engaged by a spur gear to translate the shutter between two positions. In one position, the x-ray beam 102 passes through a hole in the shutter and thereafter strikes the surface of the sample 104. In the other shutter position, the x-ray beam is blocked from exiting the analyzer 100.

A more detailed description of a hand-holdable XRF analyzer is available in co-pending, commonly-assigned U.S. patent application Ser. No. 12/029,410, titled “Small Spot X-ray Fluorescence (XRF) Analyzer,” the entire contents of which are incorporated by reference herein for all purposes, although the spot size of the primary x-ray beam need not be as small as described in the above-referenced patent application.

### Pistol Grip and in-Line Configurations

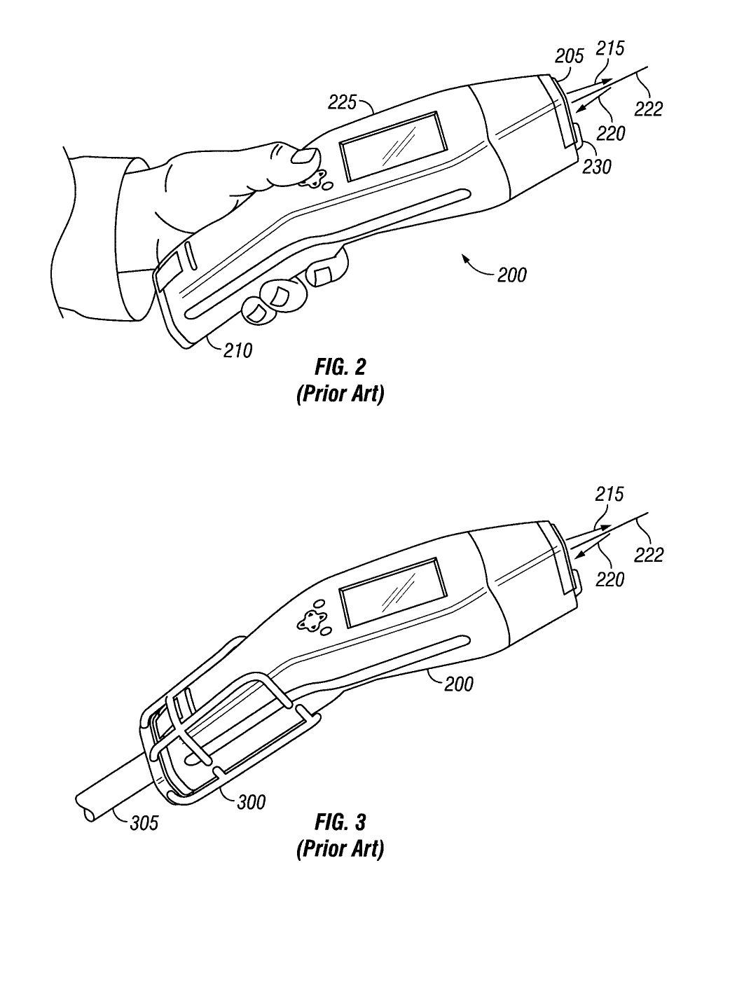

Portable, hand-holdable XRF analyzers are available in basically two configurations: “in-line” and “pistol grip.” A typical in-line analyzer has an overall shape, and is held and operated in a manner, similar to a television remote control transmitter. FIG. 2 is a perspective view of a typical prior-art, in-line XRF analyzer 200. Such an in-line XRF analyzer is available from Thermo Fisher Scientific, NITON Analyzers, Billerica, Mass., under the tradename NITON XLi analyzer. Primary x-rays exit from, and characteristic fluorescent x-rays emitted from a sample are received at, a business end 205 of the analyzer opposite an end 210 grasped by a user, and along axes 215 and 220, respectively. A business end axis 222 is approximately in line with a body 225 of the analyzer 200. In use, when the business end 205 of the analyzer 200 is brought into physical contact with a sample surface (not shown), a spring-loaded safety interlock switch 230 on the business end 205 is depressed by the sample, thus enabling the analyzer 200 to produce primary x-rays. The interlock switch 230 prevents emission of x-rays outside the analyzer 200 unless the end 205 of the analyzer 200 is pressed against a sample.

As shown in FIG. 3, an optional mechanical extension arm 300 may be attached to the end 210 of the XRF analyzer 200, thus enabling the user to reach a sample that is located some distance from the user. The extension arm 300 may include an extension pole 305. It should be noted that the business end axis 222 is approximately in line with the extension pole 305.

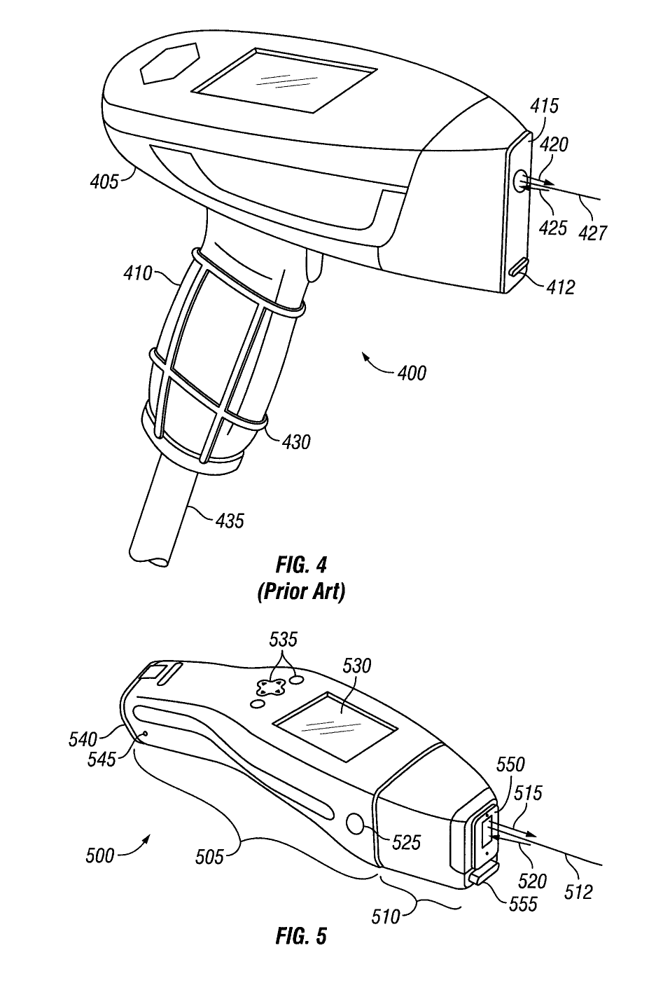

FIG. 4 is a perspective view of a typical prior-art pistol grip XRF analyzer 400. Such an XRF analyzer is available from Thermo Fisher Scientific, NITON Analyzers, Billerica, Mass., under the tradename NITON XLt analyzer. As shown in FIG. 4, the pistol grip analyzer 400 has a body 405 and a depending handle 410, collectively configured roughly in the shape of a “T.” The analyzer 400 includes a safety interlock switch 412 and emits primary x-rays and receives emitted characteristic fluorescent x-rays at a business end 415 of the body 405, along axes 420 and 425. A business end axis 427 is approximately in line with the body 405 and approximately perpendicular to the handle 410. An optional mechanical extension arm 430, including an extension pole 435, may be attached to the handle 410 to enable a user to reach a distant sample.

### Shortcomings of Prior-Art Analyzers

As noted, portable XRF analyzers are used in scrap metal recycling facilities and other contexts. For example, such analyzers are used to analyze compositions of pipes, including the compositions of welds in the pipes, as well as coating thicknesses at various points. However, neither pistol grip nor in-line analyzers are suitable for analyzing welds and other portions of inner surfaces of small-diameter pipes and in other small hollow objects, even when these analyzers are attached to extension arms. Pistol grip analyzers are too large to fit into such small objects. Although in-line analyzers may be small enough to fit into small-diameter pipes, etc., their primary and characteristic fluorescent x-rays are oriented such that their business end axes are approximately in-line with their bodies and their extension poles. Such an orientation does not permit analyzing materials located on or in the surfaces of these objects, because these surfaces are typically approximately parallel to the axes of the extension poles.

### Articulated Head Analyzer

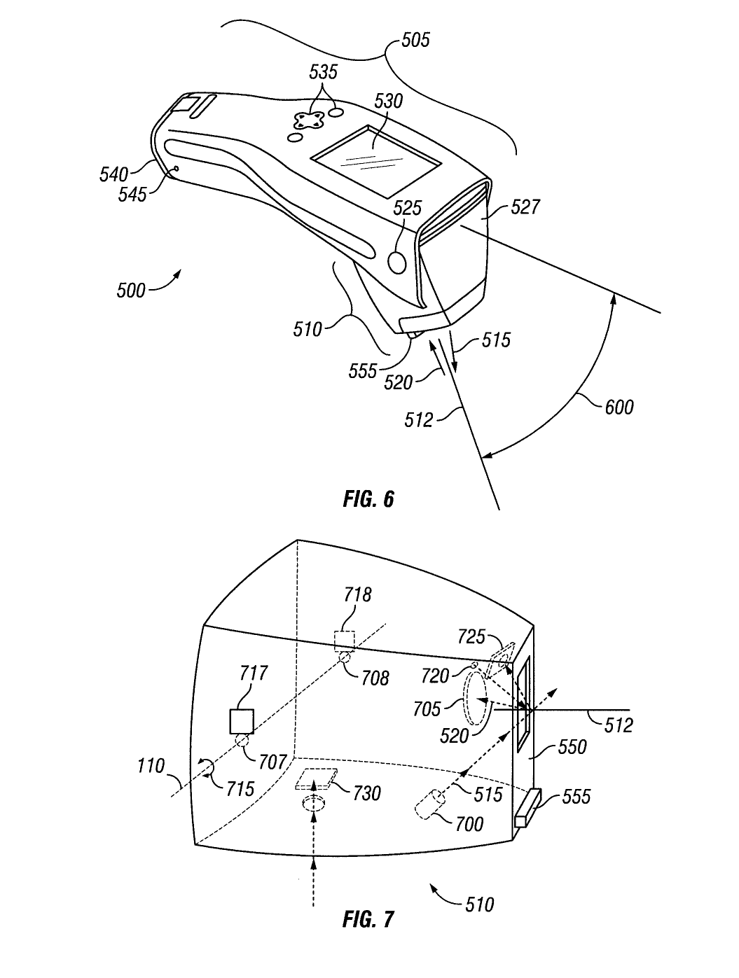

FIGS. 5 and 6 contain perspective views of a self-contained, hand-holdable XRF analyzer 500, according to one embodiment of the present invention. The analyzer 500 includes a body 505 and a head 510 that is adjustably attached to the body 505, such that the orientation of the head 510, relative to the body 505, is user adjustable. Adjusting the orientation of the head 510 correspondingly adjusts the orientation of the business end axis 512, relative to the body 505. For example, the head 510 may be adjusted, such that the head 510 and the business end axis 512 are oriented to be in line with the body 505, as shown in FIG. 5, or at an angle 600, relative to the body 505, as shown in FIG. 6. In some embodiments, the head 510 may be adjusted to be intermediate the in-line and the angled orientations. The head 510 is described herein as “articulated,” because the orientation of the head 505 may be adjusted, relative to the body 505. In contrast, the orientations of prior-art analyzers are fixed roughly in line with their bodies, as shown in FIGS. 2-4.

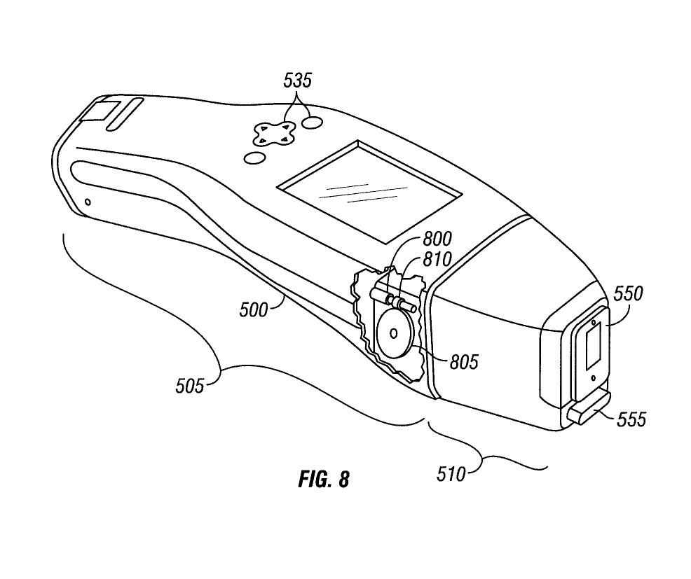

FIG. 7 is a perspective schematic diagram of the head 510. The head 510 includes an x-ray source 700, such as an x-ray tube or a radioisotope, for producing a primary x-ray beam 515. The head 510 also includes a detector 705 for detecting characteristic fluorescent x-rays 520 emitted from a sample. Primary filters (not shown) may be introduced between the x-ray source 700 and the sample to adjust the energy versus intensity spectrum of the primary x-ray beam 515. If the primary x-ray source is an x-ray tube, the voltage supplied to the x-ray tube may be varied to adjust the energy of the primary x-ray beam 515. The head 510 may also include a source collimator, detector collimator, preamplifier, shutter, thermoelectric cooling, shielding, etc. (not shown), as needed.

The x-ray source 700 and the detector 705 are disposed within the head 510, such that the axes 515 and 520 of the x-ray beams are fixed, relative to the head 510. Thus, the orientations of the axes 515 and 520 of the x-ray beams change as the orientation of the head 510 changes, relative to the body 505. In contrast, in the prior art, the orientations of the axes 215, 220, 420 and 425 of the x-ray beams (FIGS. 2-4) are fixed in-line with the bodies 225 and 405 of the analyzers 200 and 400.

In some embodiments, the analyzer 500 includes a pair of hinge mechanisms, schematically indicated at 707 and 708, about which the head 510 may pivot, with respect to the body 505, as indicated by axis 710 and arrow 715. Returning to FIGS. 5 and 6, a latch 717 and 718 is coupled to the body 505 or to the head 510 to maintain the head 510 at a set orientation, and a button 525 (FIGS. 5-6) enables a user to release the latch 717, 718, so the head 510 may be reoriented. A suitable seal 527, such as an accordion-folded resilient sheet, may be used to prevent environmental contaminants entering the body 505 or head 510 of the instrument 500.

The hinge mechanisms 707 and 708 (FIG. 7) may include a number of detents at predetermined angles 600 to facilitate orienting the head 510. Two such detents may be configured such that, when one of the detents is engaged, the head 510 is oriented perpendicular to the body 505, and when the other detent is engaged, the head 510 is orientated in line with the body 505 or at some other predetermined angle 600, relative to the body 505. In some embodiments, the head 510 may be set by the user at any angle, within a range, relative to the body 505. In other embodiments, the head 510 may be set by the user at only predetermined angles within a range. In either case, the range of angles should be at least about 45°. In some embodiments, the range of angles is about 90° or greater. The range of angles should encompass angles that facilitate operating the analyzer 500 by hand outside a pipe and for operating the analyzer 500 within a pipe or other hollow object, as discussed in more detail herein, although any suitable range of angles may be used.

FIG. 8 is a cut-away, perspective view of an embodiment of a motorized hinge mechanism, collectively referred to herein as a “head articulator.” A motor 800 is coupled to the body 505, and a worm wheel 805 is coupled to the head 510. The motor 800 drives a worm 810, which engages the worm wheel 805 to adjust the orientation of the head 510, relative to the body 505 of the analyzer 500. The motor 800 operates under control of the processor, under direct control of the operator interface buttons 535 and/or under remote control. Some embodiments include a wired or wireless port 545 for receiving signals to remotely control the orientation of the head 510 and/or to control other aspects of the analyzer 500, such as initiating an analysis. For example these signals may be processed by the processor to control the motor 800, or the signals may directly control the motor 800.

Returning to FIG. 5, the analyzer 500 also includes: a screen 530 (such as a built-in touchscreen or non-touch-sensitive screen or an attached personal digital assistant (PDA)) for displaying analytical results and images and (optionally) receiving operator inputs; a processor and memory (not visible) for storing analytical data and instructions for controlling operation of the analyzer 500; operator interface buttons 535, such as a trigger switch for initiating an analysis; and a detachable rechargeable battery 540 for powering the electrical components of the analyzer 500. As noted, the analyzer 500 may include a port 545 for receiving signals to remotely control the orientation of the head 510, trigger the analyzer 500 or for other purposes, as described in more detail below.

Optionally, as shown in FIG. 7, the head 510 includes a light source 720, such as a light-emitting diode (LED), oriented to illuminate a portion of the sample where the primary x-ray beam 515 strikes, or would strike, the sample. In addition, the head 510 may include a digital camera 725 oriented toward the illuminated portion of the sample. Collectively, the light source 720 and the camera 725 may be used to generate an image of the sample, where the primary x-ray beam 515 strikes, or would strike, the sample, thereby facilitating aiming the analyzer 500 at a portion of the sample that is of interest. The image may also be stored internally or externally as a record of the portion of the sample that was analyzed. Optionally, the analyzer 500 may generate a reticule in the displayed image to indicate the portion of the sample that is, or would be, illuminated by the x-ray beam. The generated image may be displayed on the screen 530 and/or transmitted via a wired or wireless link to be displayed on a remote screen or stored in a remote computer (not shown).

In operation, a business end 550 of the head 510 is pressed against a sample (not shown). When the business end 550 comes into contact with the sample, a safety interlock switch 555 on the business end 550 is depressed by the sample to enable the analyzer 500 to produce a primary x-ray beam 515. In embodiments of the analyzer 500 that utilize x-ray tubes to produce the primary x-rays 515, the state of the safety interlock switch 555 may be sensed by the processor to selectively trigger a high-voltage power supply (not shown) coupled to the x-ray tube. In embodiments of the analyzer 500 that utilize radioactive isotopes, the state of the safety interlock switch 555 may be sensed by the processor to actuate a mechanical shutter (not shown) that selectively blocks or passes radiation from the isotope.

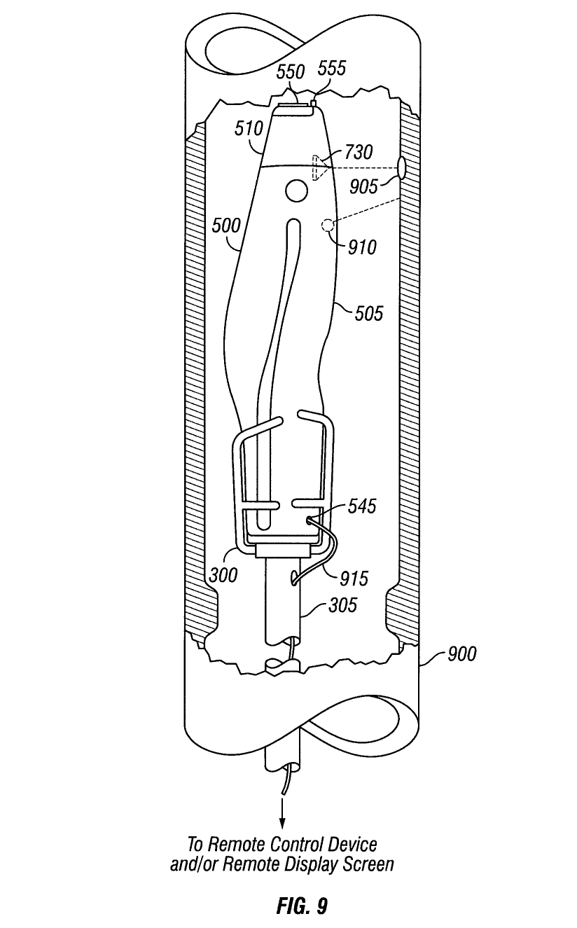

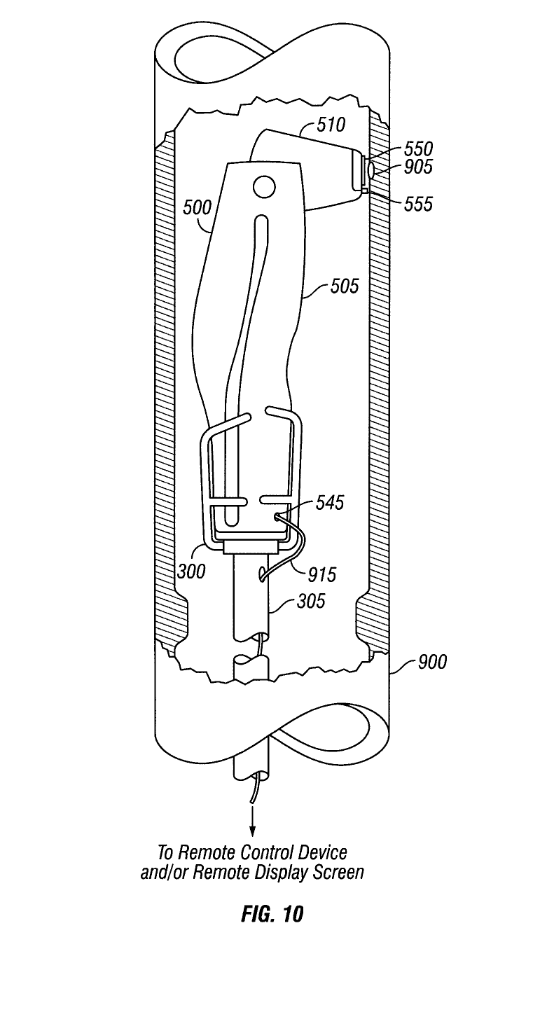

FIG. 9 is a cut-away view of a pipe 900, into which the analyzer 500 has been inserted. An extension arm 300, including an extension pole 305, may be used to insert the analyzer 500 into the pipe 900. In certain implementations, the extension arm may be formed at least partially as a flexible or bendable structure (e.g., a flexible cable) to facilitate the insertion and guiding of analyzer 500 through a curved or branched pipe or similar elongated conduit. As can be seen, the inside diameter of the pipe 900 is insufficient to insert a prior-art pistol grip analyzer, such as the analyzer illustrated in FIG. 4. However, the head 510 of the analyzer 500 may be oriented in line with the body 505 of the analyzer to facilitate inserting the analyzer 500 into the pipe 900 or other object. Once the analyzer 500 has been inserted into the pipe 900 or other object and positioned near a location of interest (such as an interior weld 905), the orientation of the head 510 may be adjusted, relative to the body 505, so the business end 550 of the head 510 is oriented toward the portion of the pipe that is to be analyzed, as shown in FIG. 10. The head 510 may be brought close enough to the location of interest to actuate the safety interlock switch 555, and the sample may be analyzed.

To facilitate positioning the analyzer 500 in a pipe interior or other dark cavity, the analyzer 500 may include a second light source 910 (FIG. 9) and a second digital camera 730 (FIGS. 7 and 9) oriented away from the side of the analyzer 500. An image produced by the second digital camera 730 may be transmitted via a wired or wireless link to an external display screen (not shown). A user may view the image displayed on the screen while manipulating the extension pole 305. Although FIG. 9 shows the second digital camera 730 within the head 510, the second camera may be located anywhere in or on the analyzer 500. Furthermore, the light source 910 may serve double duty and, thereby, obviate the need for the first light source 720 (FIG. 7).

As noted, the analyzer 500 may include a port 545 for receiving signals to remotely control the orientation of the head 510 and other aspects of the analyzer 500. A cable 915 may be connected between the port 545 and a remote control device (not shown) that generates the remote control signals. Optionally or additionally, the port 545 may be used to transmit the images generated by either or both digital cameras 725 and 730 to the remote display screen.

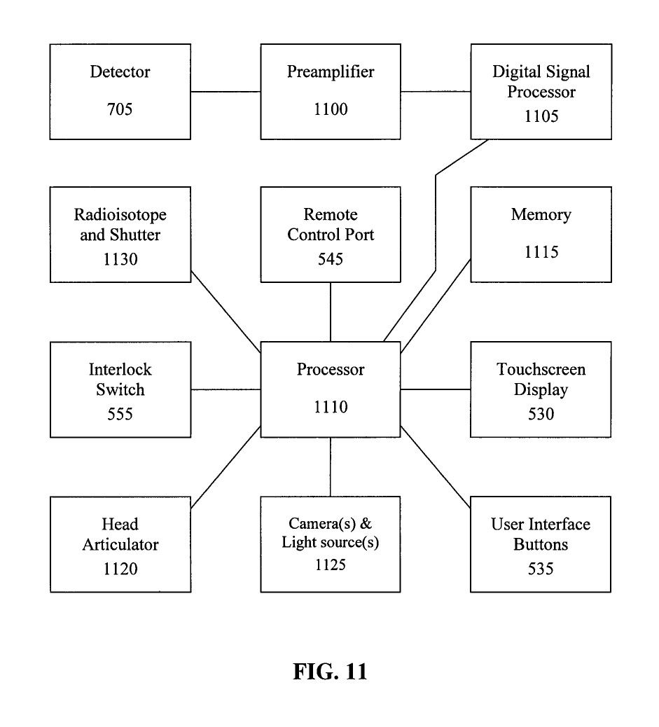

As noted, some XRF analyzers use x-ray tubes, and other XRF analyzers use radioisotopes, as primary x-ray sources. FIG. 11 is a schematic block diagram of an XRF analyzer that uses a radioisotope, according to one embodiment. The XRF analyzer includes a detector 705, safety interlock switch 555, display screen 530 and user interface buttons 535, as described above. The XRF analyzer also includes a preamplifier 1100 coupled to the detector 705 and a digital signal processor (DSP) 1105 coupled between the preamplifier 1100 and a main processor 1110. Instructions for the processor 1110 and/or analytical data, tables of alloy compositions, etc. may be stored in a memory 1115 that is coupled to the processor 1110. A head articulator is shown at 1120, and the light sources 720 and 910 and the digital cameras 725 and 730, described above, are shown collectively at 1125. The processor 1110 controls operations of the various described subsystems, including a shutter/radioisotope subsystem 1130.

### Powering X-Ray Tubes

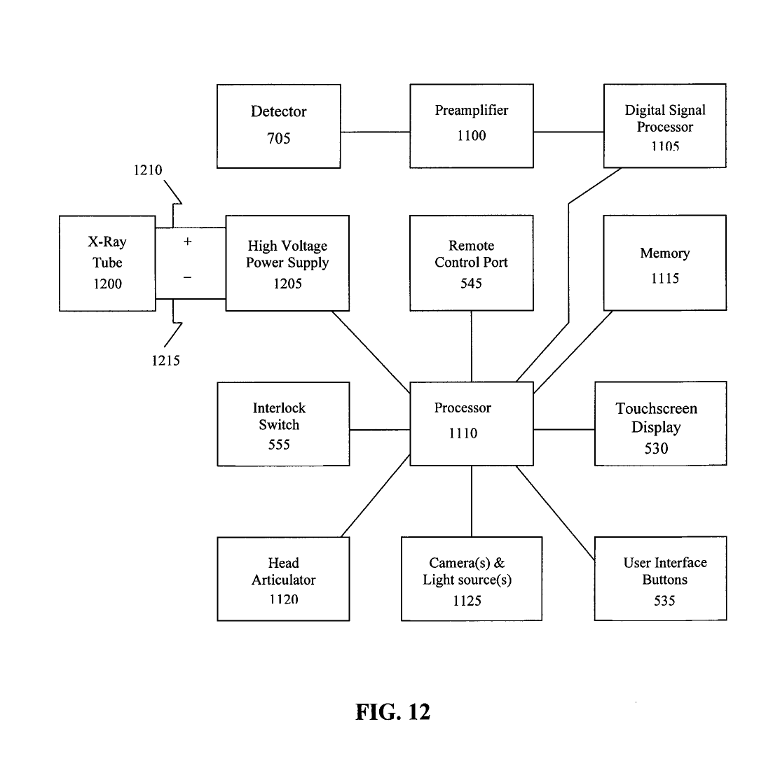

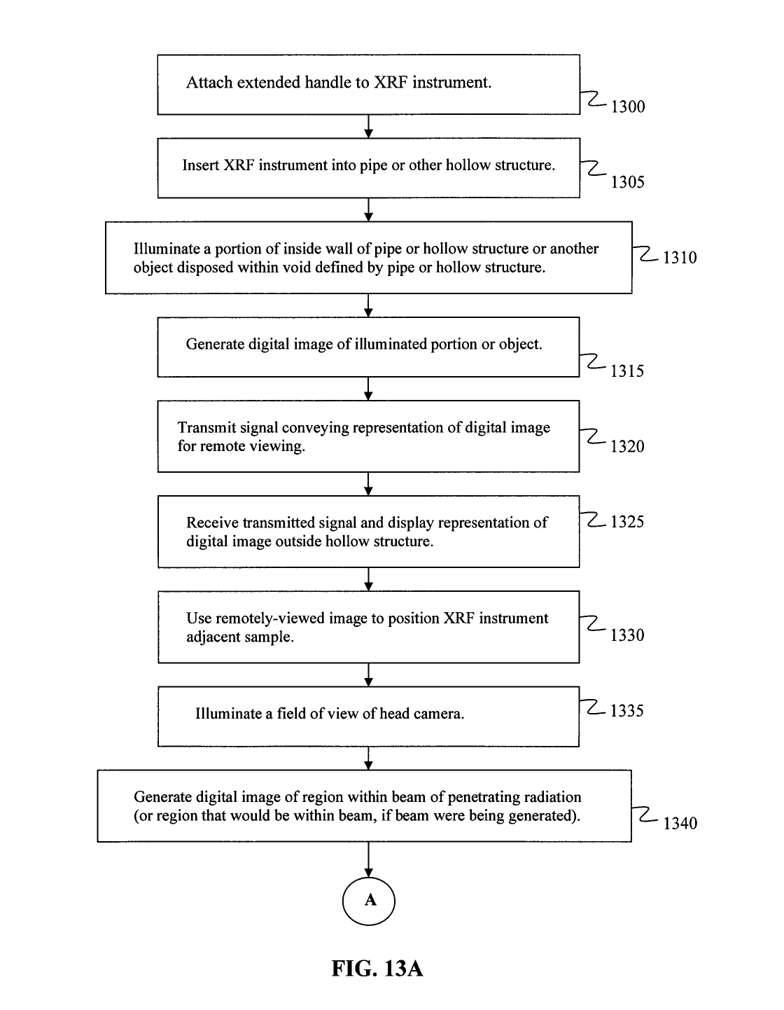

FIG. 12 is a schematic block diagram of an XRF analyzer that uses an x-ray tube 1200 as a primary x-ray source. A high-voltage power supply 1205, which is controlled by the processor 1110, is connected to the x-ray tube 1200 to operate the tube. Most of the analyzer's other subsystems are similar to those described above, with respect to FIG. 11.

In an exemplary prior-art hand-holdable XRF analyzer, a high-voltage power supply, such as a Cockroft-Walton (CW) generator, provides about −50 kV to the cathode of an x-ray tube via a high-voltage cable, while the anode of the x-ray tube and the power supply are connected to a common ground with other circuits of the analyzer. However, such a high-voltage power supply may be too large to fit in the articulated head 510 of the analyzer 500. If so, the high-voltage power supply 1205 may be disposed in the body 505 and may be connected to the x-ray tube 1200 by a flexible cable. However, 50 kV cable that is suitably flexible and suitably small in diameter may not be readily available.

This problem may be overcome by connecting the high-voltage power supply 1205 to the x-ray tube 1200 via two separate high-voltage cables 1210 and 1215. Such a combination is available from Newton Scientific, Inc., Cambridge, Mass. 02141. Cable 1210 provides +25 kV (relative to ground) to the anode of the x-ray tube 1200, and cable 1215 provides −25 kV (relative to ground) to the cathode of the x-ray tube 1200. The target end of the x-ray tube 1200, which is near the business end 550 (FIG. 5) of the head 510, should be suitably insulated to protect a user of the analyzer 500 and sensitive components in the analyzer 500. Each of the cables 1210 and 1215 needs to be suitable for handling only 25 kV. Suitable cables include UL Style 3239 cable, available from Allied Wire and & Cable, Collegeville, Pa. 19426. Shielded coaxial cables may be used, when needed, to protect nearby electronic components. In such cases, the cable shield may be grounded.

A portion of each of the two cables 1210 and 1215 may extend along the hinge axis 710 (FIG. 7), such that pivoting of the head 510, relative to the body 505, causes the portion of the flexible conductor to twist about the hinge axis 710, rather than actively bend. Twisting a length of flexible conductor about its longitudinal axis exerts less stress on the flexible conductor than if the flexible conductor is repeatedly bent across its longitudinal axis. The cables 1210 and 1215 may be positioned along the hinge axis 710, such that no torque is applied to the cables 1210 and 1215 when the head 510 is positioned approximately half-way through its range of pivot, thereby minimizing the amount of twisting, and therefore stress, the cables 1210 and 1215 must endure. Strain relief should be provided near each end of each cable 1210 and 1215 to reduce the amount of stress or movement where each cable joins the high-voltage power supply 1205 and the x-ray tube 1200, respectively.

A slip joint or other rotating electrical connector inside an insulated tube filled with a suitable insulating material, such as Fluorinert electronic liquid (available from 3M, St. Paul, Minn. 55144), and sealed with “O” rings may be used instead of, or in addition to, flexing either or both of the cables 1210 and 1215. In another embodiment, miniature liquid metal rotating electrical connectors, similar to Model 110 or Model 110-T connectors available from Mercotac, Inc., Carlsbad, Calif. 92011, may be used with suitable insulation.

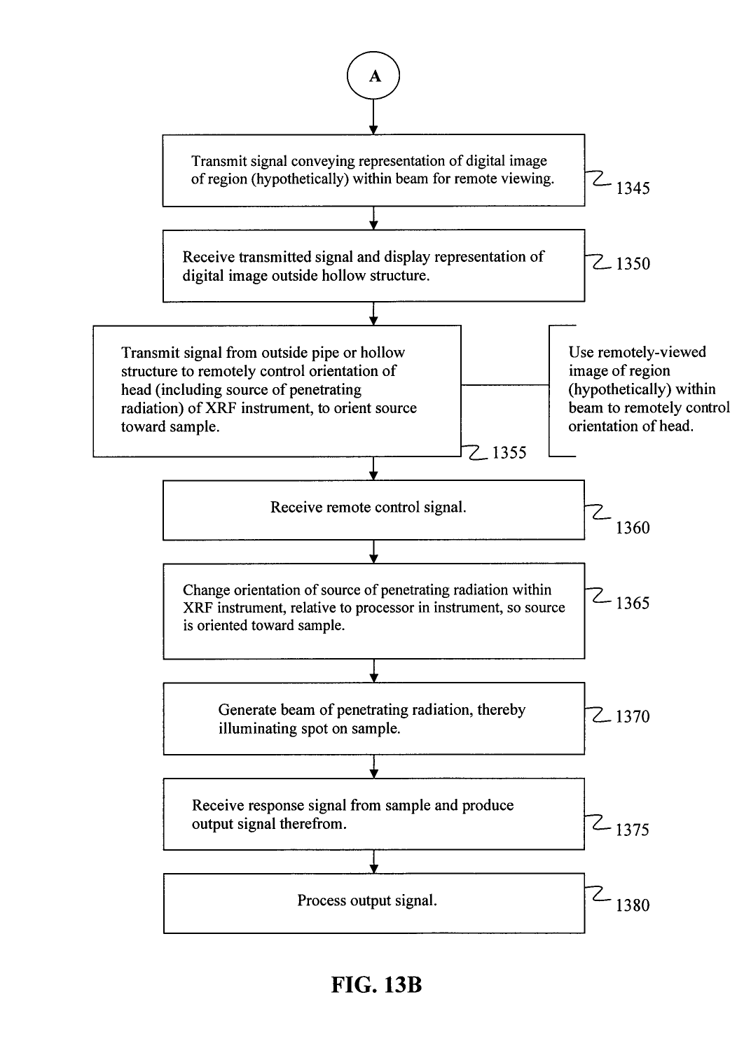

FIG. 13 contains a flowchart depicting operations that may be performed to analyze an inner portion of a pipe or other structure. At 1300, an extended handle, such as an extension arm 300 and/or extension pole 305, is attached to an XRF instrument. At 1305, the instrument is inserted into the pipe or other structure. At 1310, a portion of the inside wall or other object in the pipe or other structure is illuminated, such as by a light source 910 on the instrument. At 1315, a digital image of the illuminated portion or object is generated, such as by a digital camera 730. At 1320, a signal conveying a representation of the generated image is transmitted, such as via a port 545 and cable 915 or wirelessly. At 1325, the signal is received, and a representation of the digital image is displayed outside the structure, such as on a display screen. At 1330, using the remotely-viewed image, the XRF instrument is positioned within the structure, so the instrument is adjacent a sample of interest.

At 1335, a second light source, such as light source 720, is used to illuminate a field of view of a second camera, such as digital camera 725, within the head of the instrument. At 1340, a second image is generated of a region within a beam of penetrating radiation, or a region that would be within the beam of penetrating radiation, if the beam were to be generated. At 1345, a second signal conveying a representation of the generated second image is transmitted, such as via the port 545 and the cable 915 or wirelessly, and at 1350, the second signal is received and a representation of the second image is displayed outside the structure, such as on a display screen.

Using the displayed second image, a user may remotely control the orientation of the head of the instrument. At 1355, a remote control signal (such as a signal generated by a remote control transmitter) is transmitted from outside the pipe or other structure, to the instrument, such as via the cable 915 or wirelessly to the port 545. At 1360, the instrument receives the remote control signal, and at 1365, the remote control signal causes the source of penetrating radiation to be reoriented, relative to the processor, so the source is oriented toward the sample. As noted, a processor in the analyzer may cause the signals representing the images to be transmitted, and the processor may respond to the received remote control signals to operate the head articulator. The processor may further control a high-voltage power supply connected to an x-ray tube, and the processor may control one or more shutters interposed between the primary x-ray source and the sample. The processor may be disposed in the body of the instrument.

Once the source of the penetrating radiation has been oriented toward the sample, at 1370, a beam of penetrating radiation is generated to illuminate a spot on the sample, thereby causing a response signal to be generated. At 1375, the response signal from the sample is received, and an output signal is generated therefrom. For example, an output signal from a DSP may be generated, as a result of detecting and amplifying the response signal from the sample. At 1380, the output signal is processed, such as by a processor, to determine composition of all or part of the sample.

Aspects of the analyzer 500 described above, or an alternative embodiment described below, may be used in conjunction with other types of analyzers, such as analyzers that employ arc/spark optical emission spectroscopy (OES), laser-induced breakdown spectroscopy (LIBS), other analytical techniques or combinations thereof. These aspects include, but are not limited to: providing an articulated head containing a business end of the analyzer; motorizing the articulated head; remotely controlling the orientation of the head, relative to a body of the analyzer; separating a power supply from components in the articulated head by one or more flexible cables; and generating images of regions proximate the analyzer and/or regions that are or would be analyzed by the analyzer and remotely displaying these images to facilitate positioning the analyzer and orienting the head of the analyzer.

Furthermore, the analyzer 500 described above may be used in other contexts. For example, the analyzer 500 may be attached to, or otherwise carried by, a robot, such as a small wheeled cart to carry the analyzer 500 to a desired location within a pipe or other hollow structure. The robot may be remotely controlled via wired or wireless signals from a remote controller. Optionally or alternatively, the robot may autonomously drive to one or more locations of interest and pause at each location while the analyzer analyzes samples. The robot may be preprogrammed with coordinates of the locations where it is to pause. The robot may ascertain its location by measuring rotation of one or more wheels, similar to the way a computer mouse ascertains its location by measuring rotation of a ball. Alternatively, the robot may include a GPS receiver to ascertain its location. Optionally, the robot may use a camera (or the camera in the analyzer) to generate an image of its surroundings and analyze the image to determine locations of likely interest. Optionally, the analyzer may perform the image capture and/or analysis and command the robot to move or stop, as appropriate.

### Fixed-Orientation Head Analyzer

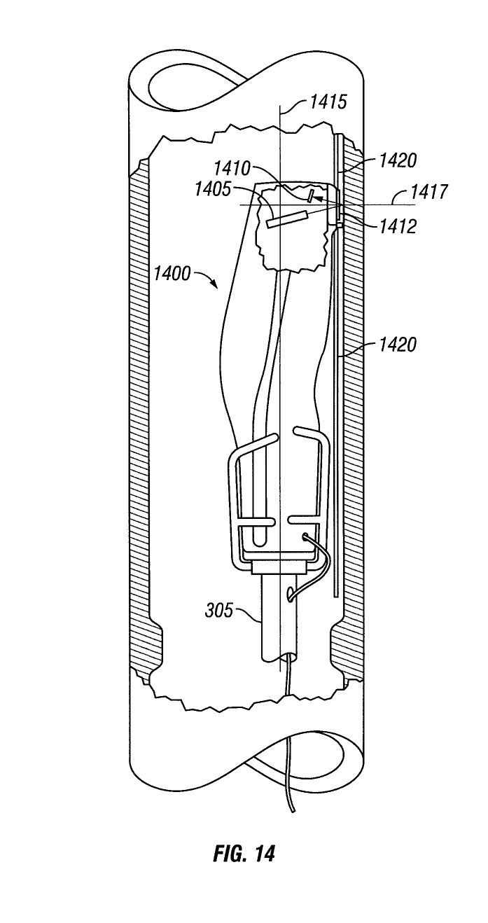

As noted, in some embodiments, the business ends are fixed in orientation, with respect to the bodies of low-profile analyzers. One such instrument 1400 is shown in FIG. 14. An x-ray source 1405, such as an x-ray tube or a radioisotope, and a detector 1410 are oriented such that a business end axis 1417 is oriented approximately perpendicular to the major axis 1415 of the instrument 1400 body. Thus, a surface that is approximately parallel to the major axis 1415 of the instrument may be analyzed.

For example, the x-ray source 1405 and the detector 1410 may each be oriented at an angle, such as about 20°, about 30°, about 50°, or any other suitable angle from the surface of the sample. The angle of the x-ray source 1405 may be equal to, or not equal to, the angle of the detector 1410. The angles may be chosen based on practical considerations, such as to minimize cross-talk between the x-ray source 1405 and the detector 1410, the depth within the sample to be analyzed or other objectives.

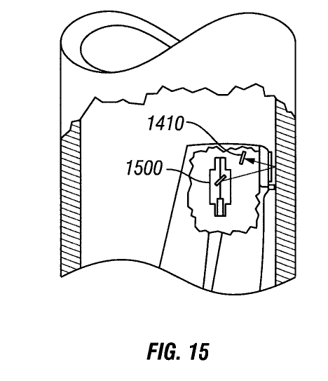

If an x-ray tube is used for the x-ray source 1405, the x-ray tube may be a target transmission type tube. Alternatively, as shown in FIG. 15, a beveled anode type x-ray tube 1500 may be used.

A flexible or rigid radiation shield (“collar”) 1420 may be used, if necessary. For example, in another context, if the analyzer 1400 is hand held, such as to analyze elemental composition of the outside of a pipe (i.e., not attached to an extension pole 305), the radiation shield 1420 may be used to protect a user from exposure to x-rays. The radiation shield 1420 may be removable, or it may be permanently attached to the instrument 1400. The radiation shield 1320 may also be used when the analyzer 1400 is deployed within a pipe or other hollow object. A suitable radiation shield is described in U.S. Pat. Nos. 6,965,118, 7,375,358 and 7,375,359, the entire contents of all of which are hereby incorporated by reference herein for all purposes.

Other aspects of the instrument 1400 may be as described above, with respect to the articulated head embodiments. For example, the head of the instrument 1400 may include a light source and a digital camera to capture an image of the sample that is analyzed, as discussed above with respect to FIG. 7. Furthermore, the body of the instrument 1400 may include a light source and a digital camera to facilitate positioning the instrument 1400 inside a dark pipe, as discussed above with respect to FIG. 9. Optionally or alternatively, the digital camera inside the head of the instrument 1400 may be used to position the instrument 1400. Similarly, the instrument 1400 may be remotely triggered, as discussed above with respect to FIG. 5.

In accordance with exemplary embodiments, a low-profile XRF analyzer having a fixed or an articulated head and a method for analyzing a sample within a pipe or other hollow object are provided. While specific values chosen for these embodiments are recited, it is to be understood that, within the scope of the invention, the values of all of parameters are design choices and may vary over wide ranges to suit different applications.

This application describes apparatus for analyzing composition of a sample, comprising: a hand-holdable, self-contained test instrument that includes a body and a business end having a business end axis orientated approximately perpendicular to a major axis of the body; the business end including: a source for producing a beam of penetrating radiation for illuminating a spot on the sample, thereby producing a response signal from the sample; and a detector for receiving the response signal and for producing an output signal; the test instrument further including: a processor coupled to the detector and programmed to process the output signal; and a battery powering the processor.

This application also describes apparatus, similar to the above-described apparatus, wherein the source for producing the beam of penetrating radiation comprises a radioisotope.

This application also describes apparatus, similar to the above-described apparatus, wherein the source for producing the beam of penetrating radiation comprises an x-ray tube.

This application also describes apparatus, similar to the above-described apparatus, wherein the body houses a high-voltage power supply powered by the battery and coupled to the x-ray tube.

This application also describes apparatus, similar to the above-described apparatus, wherein the processor and the battery are housed within the body.

This application also describes apparatus, similar to the above-described apparatus, wherein:

the business end further comprises a digital camera powered by the battery and oriented so as to generate an image of a region that is, or would be, within the beam of penetrating radiation; and the test instrument further includes a port configured to send a signal conveying a representation of an image generated by the digital camera for remote viewing.

This application also describes apparatus, similar to the above-described apparatus, wherein: the body further comprises a digital camera powered by the battery; and the test instrument further includes a port configured to send a signal representing an image generated by the digital camera for remote viewing.

While the invention is described through the above-described exemplary embodiments, it will be understood by those of ordinary skill in the art that modifications to, and variations of, the illustrated embodiments may be made without departing from the inventive concepts disclosed herein. For example, although some functions of the XRF analyzer have been described with reference to a flowchart or block diagram, those skilled in the art should readily appreciate that functions, operations, decisions, etc. of all or a portion of each block, or a combination of blocks, of the flowchart or block diagram may be combined, separated into separate operations, omitted or performed in other orders. Furthermore, disclosed aspects, or portions of these aspects, may be combined in ways not listed above. For example, an instrument with an articulated head may include a radiation shield. Accordingly, the invention should not be viewed as limited to the disclosed embodiments.

An XRF analyzer has been described as including a processor controlled by instructions stored in a memory. The processor may be a single processor, or a combination of processors, to perform the functions described herein. The memory may be random access memory (RAM), read-only memory (ROM), flash memory or any other memory, or combination thereof, suitable for storing control software or other instructions and data. The memory may be a single memory or a combination of several memories.

Some of the functions performed by the XRF analyzer have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

What is claimed is:

1. Apparatus for analyzing composition of a sample, comprising:
a hand-holdable, self-contained, test instrument that includes a body and a head adjustably attached to the body, such that the orientation of the head, relative to the body, is user adjustable over a range of at least about 45′;
the head including:
a source for producing a beam of penetrating radiation for illuminating a spot on the sample, thereby producing a response signal from the sample; and
a detector for receiving the response signal and for producing an output signal;
the test instrument further including:
a processor coupled to the detector and programmed to process the output signal; and
a battery powering the processor.

2. Apparatus, according to claim 1, wherein the source for producing the beam of penetrating radiation comprises a radioisotope.

3. Apparatus, according to claim 1, wherein the source for producing the beam of penetrating radiation comprises an x-ray tube.

4. Apparatus, according to claim 3, wherein the body houses a high-voltage power supply powered by the battery and coupled to the x-ray tube.

5. Apparatus, according to claim 4, wherein the high-voltage power supply is coupled to the x-ray tube via separate positive and negative, relative to a common ground within the test instrument, high voltage leads.

6. Apparatus, according to claim 1, wherein the processor and the battery are housed within the body.

7. Apparatus, according to claim 1, wherein the test instrument further includes a user-operable latch releasably securing the head orientation, relative to the body.

8. Apparatus, according to claim 1, the test instrument further includes an articulator coupled to the body and to the head and configured to adjust the head orientation, relative to the body.

9. Apparatus, according to claim 8, wherein the test instrument further includes a port configured to receive signals to remotely control the articulator.

10. Apparatus, according to claim 1, wherein:
the head further includes a digital camera powered by the battery and oriented so as to generate an image of a region that is, or would be, within the beam of penetrating radiation; and
the test instrument further includes a port configured to send a signal conveying a representation of an image generated by the digital camera for remote viewing.

11. Apparatus, according to claim 1, wherein:
the body further includes a digital camera powered by the battery; and
the test instrument further includes a port configured to send a signal representing an image generated by the digital camera for remote viewing.

12. A method for analyzing composition of a sample from within a hollow structure, the method comprising:
inserting an XRF analyzer into a void defined by the structure;
changing an orientation of a source of penetrating radiation within the XRF analyzer, relative to a processor of the XRF analyzer, such that an output of the source is oriented toward the sample;
generating a beam of penetrating radiation, thereby illuminating a spot on the sample;
receiving a response signal from the sample and producing an output signal therefrom; and
processing the output signal.

13. A method according to claim 12, wherein changing the orientation of the source of penetrating radiation comprises:
transmitting a remote control signal from outside the hollow structure; and
receiving the remote control signal and changing the orientation of the source of penetrating radiation in response to the received remote control signal.

14. A method according to claim 12, further comprising:
generating a digital image of a region within the hollow structure;
transmitting a signal conveying a representation of the digital image; and
receiving the transmitted signal and displaying the representation of the digital image outside the hollow structure.

15. A method according to claim 12, further comprising:
generating a digital image of a region that is within the beam of penetrating radiation, or would be within the beam of penetrating radiation if the orientation of the source of penetrating radiation were changed; and
transmitting a signal conveying a representation of the digital image.

16. A method according to claim 15, further comprising receiving the transmitted signal and displaying the representation of the digital image outside the hollow structure.

17. A method according to claim 12, wherein inserting the XRF analyzer comprises carrying the XRF analyzer within the hollow structure on a robot.

18. A method according to claim 17, further comprising remotely controlling the robot.

19. A method according to claim 17, further comprising automatically controlling operation of the robot.
